(19) United States
(12) Patent Application Publication
(10) Pub. No.: US 2002/0047920 A1
(43) Pub. Date: Apr. 25, 2002

(54) TELEVISION SYSTEM DESIGNED FOR CONVENIENTLY MODIFYING ANY INTERNALLY STORED DIGITAL DATA

(75) Inventor: BRYAN MICHAEL RICHTER, FREMONT, CA (US)

Correspondence Address: NARENDRA R. THAPPETA, LANDON & STARK ASSOCIATES, ONE CRYSTAL PARK, SUITE 210, 2011 CRYSTAL DRIVE, ARLINGTON, VA, 22202, US

(73) Assignee: TeleCruz Technology, Inc.

(21) Appl. No.: 09/157,830

(22) Filed: Sep. 21, 1998

(51) Int. Cl. H04N 7/00; H04N 11/00

(52) U.S. Cl. 348/460; 348/552

(57) ABSTRACT

Data stored internally in a television system is modified conveniently. New data is stored on a video tape. A user of a television system simply needs to play the video tape on a video cassette player to change pre-stored data in the television system. The video signal resulting from playing the video tape is provided to the television system. The television system examines the received video signal to recover the encoded new data and uses the new data to modify the pre-stored data. For example, the pre-stored data may be replaced by the new data.

### RELATED APPLICATIONS

The present application is related to the following co-pending U.S. Patent Applications, which are incorporated by reference in their entirety herewith:

1. Patent application entitled, “A Method and Apparatus for Enabling a User to Access Data Network Applications from a Television System”, Filed Jun. 2, 1997, Ser. No. 08/867,203 (hereafter “RELATED APPLICATION 1”);

2. Patent Application Entitled, “A Method and Apparatus for Reducing Flicker in the Television Display of Network Application Data”, Filed on Dec. 31, 1997, Ser. No. 09/001,410 (“RELATED APPLICATION 2”);

3. Patent Application Entitled, “Television System For Recovering Digital Data Encoded in a Television Signal”, Filed on even date herewith, Serial Number Unassigned, and Attorney Docket Number: TCRZ-0008 (“RELATED APPLICATION 3”); and

4. Patent Application Entitled, “A Television System Providing for Flexible Display of Images Encoded in a Television Signal Along with Images Representing Network Application Data”, Filed on even date herewith, Serial Number Unassigned, and Attorney Docket Number: TCRZ-0015 (“RELATED APPLICATION 4”).

### BACKGROUND OF THE INVENTION

1. Field of the Invention

The present invention relates to television systems, and more specifically to a method and apparatus for conveniently changing any digital data stored within a television system.

2. Related Art

Television systems are widely used to view images encoded in video signals. Video signals may be received from broadcasters or provided from local video storage devices such as video cassette recorders, laser disk payers. A television system generally receives video signals in a pre-defined format (e.g., composite video signal in NTSC format), and displays the encoded images on a display screen in a known way.

A television system may store digital data internally, typically in a non-volatile memory. The digital data may be used in one of several ways. For example, the data may represent a program (including instructions and program data) which when executed provides a desired feature. RELATED APPLICATION 1 and RELATED APPLICATION 2 referred to above, describe example implementations of television systems which may store programs to display television signal images along with network application data (e.g., to allow web-browsing). The stored digital data may also represent configuration parameters of a television system, which control the operational aspects of the television system.

The digital data stored internally in a television system may need to be modified for one of several reasons. For example, the program may need to be upgraded or the configuration parameters of the television system may need to be changed. In general, the modification of the data needs to be simple such that the data can be modified without extensive technical experience or manual labor.

The digital data in a television system may be modified using one of several techniques. For example, a serial interface may be provided in the television system, and data may be provided over the serial interface. Such a technique usually requires an external server (such as a personal computer), which would transfer data according to a predetermined format. Unfortunately, the provision of additional interfaces in a television system may be expensive and thus undesirable.

In another technique, the data may be stored in a “smart-card” (e.g., made of flash memory) and the smart-cards may be replaced to modify the data. Unfortunately, smart-cards can be expensive. In addition, replacement may require a level of skill or knowledge, which may not be available in many households in which television systems are typically used. At least for such a reason, a smart-card based modification technique may be undesirable.

Therefore, what is needed is a method and apparatus which allows the digital data stored in a television system to be modified easily.

### SUMMARY OF THE INVENTION

The present invention allows pre-stored data in a television system to be modified by playing a video storage medium (e.g., video cassette) in a video player (e.g., video cassette player). New data used for modification of the pre-stored data is stored on the video storage medium such that the data is included in a video signal generated by playing the video storage medium in the video player.

A television system receives the video signal including the new data, and recovers the new data by examining the video signal. The recovered data is used to modify the pre-stored data. For example, a portion or all of the pre-stored data may be replaced by the recovered data.

In one embodiment, the new data is encoded in the vertical blanking interval (VBI) portion of the video signal. Data synchronization signals can also be encoded (preferably in each horizontal line) for accurate recovery of the new data. For example, the data synchronization signals can be used to synchronize a sampling clock signal used for sampling a video signal, and such synchronization enables the video signal to be sampled at appropriate points of the video signal to recover the new data.

Therefore, the present invention provides a simple method and apparatus to modify pre-stored data in a television system. This is accomplished by providing new data on a video storage medium and playing the video storage medium in a video player. The video signal generated by such playing include the new data, which is used by the television system to modify the pre-stored data.

The present invention enables internally stored data to be modified without requiring substantial changes to the external interfaces of a television system as the data used for modification is sent to the television system using display signals.

The present invention provides considerable flexibility in the format of the video signal because the video signal with the new data can be generated and used only locally, and thus may not need to be broadcast to other television systems.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, wherein:

FIG. 1 is a block diagram of an example system including a television system, a video cassette, and a video cassette player (VCP) in accordance with the present invention;

FIG. 2 is a flow-chart illustrating a method in accordance with the present invention; and

FIG. 3 is a block diagram of a television system illustrating an embodiment in accordance with the present invention.

### DETAILED DESCRIPTION OF THE PREFERRED EMBODIMENTS

1. Overview and Discussion of the Invention

The present invention is directed to a television system which stores digital data (“pre-stored data”). The pre-stored data can be modified in accordance with the present invention by using a video player and a local video storage medium. Data (“new data”) is stored on a local video storage medium. The new data may be stored in a format such that the new data is available in a video signal when the video storage medium is played in a video player.

A video player reads the video signal with the encoded data from a local video storage medium, and provides the video signal to a television system. The television system can decode the data by examining the received video signal, and use the decoded data to modify any pre-stored data. For example, the decoded data (or recovered new data) may simply replace the pre-stored data.

In addition, as the video signal is generated based on a locally played video-tape, agreement on the format may not be needed as would be otherwise required if the video signal were provided by a broadcast provider. That is, in general, the format of video signals broadcast for use by television systems need to conform to pre-defined convention. However, as the video signal can be provided from a local video player (or point-to-point connection in general) in accordance with the present invention, rigid conformance to conventions may not be required.

As the encoded data is provided in the form of a video signal, a television system in accordance with the present invention can receive the encoded data using hardware which is otherwise available for displaying conventional video signals. Thus, the present invention enables modification of stored data by using interfaces otherwise available for processing video signals.

The present invention is described in further detail below with reference to several example methods and implementations. For illustration, a videotape and a video cassette player commonly available in households are chosen as examples of local storage medium and video player respectively. However, other video storage media and video players can be implemented using one of several cooperating technologies and implementations without departing from the scope and spirit of the present invention. Digital video disk (DVD), laser disk and CD-ROM are some examples of such implementations and technologies.

2. Method According to the Present Invention

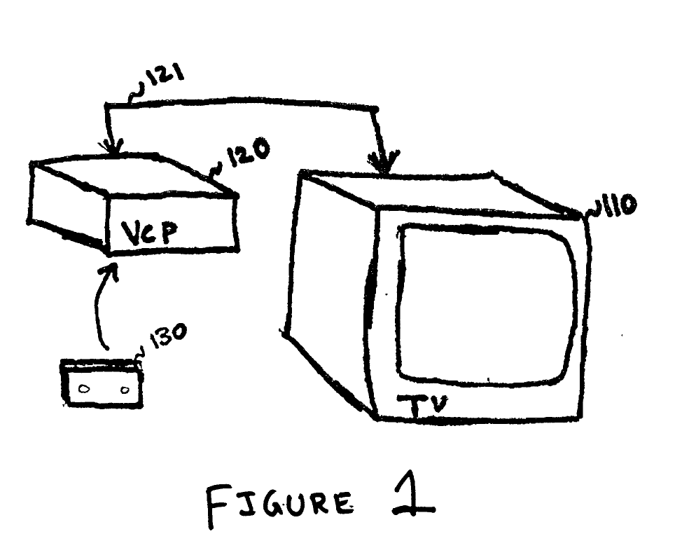

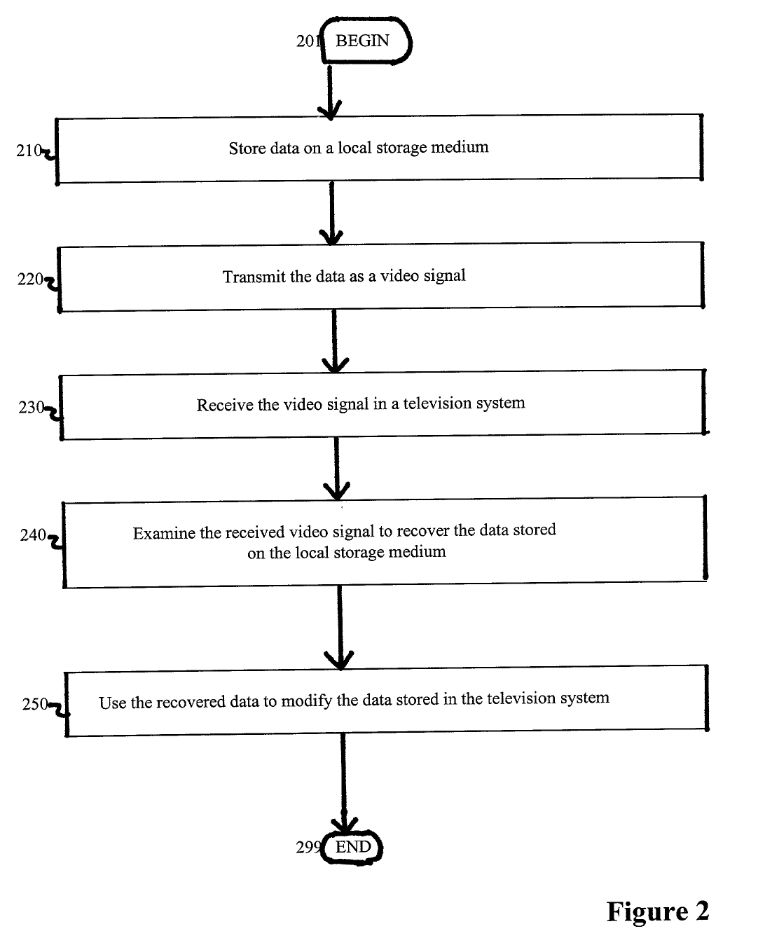

A method according to the present invention is described with combined reference to FIGS. 1 and 2. FIG. 1 is a block-diagram depicting television system 110, video cassette player (VCP) 120, and video tape 130. FIG. 1 illustrates an example system in which the present invention can be implemented. FIG. 2 depicts a flow-chart illustrating a method according to the present invention. The data in television system 110 is modified in accordance with the method of FIG. 2.

Continuing with combined reference to FIGS. 1 and 2, new data is stored on video tape 130 in step 210. In step 220, VCP 120 retrieves the data from video tape 130, and transmits the data in the form of a video signal on line 121. Line 121 represents a communication path between VCP 120 and television 110, and may be implemented using a cable which transmits NTSC video signals. In step 230, the video signal is received in television system 110, and the encoded data is recovered in step 240. The recovered data is used to modify the pre-stored data in step 250.

To allow for recovery in step 240, the data needs to be stored, retrieved and transmitted according to predetermined conventions in steps 210, 220, and 230. For example, data may be stored in the vertical blanking interval (VBI) portions of a video signal stored on video tape 130. As is well known, VBI portion corresponds to a non-display time duration in which scan electronics of analog display screens retrace from the bottom to the top of the display screen. The data may include data synchronization signals used during data recovery process in television 110.

VCP 120 can read the signal stored on video tape 130 as if common video signal representing images is stored on videotape 130. One of several known techniques can be used to encode data into VBI portions such that VCPs commonly available in the market place can read the stored data.

It needs to be generally remembered that the encoding rate needs to low (compared to, for example, teletext data) to be able to reproduce the data accurately from a VCP. In one embodiment, the data may be encoded at the rate closed-captioning information is encoded. However, instead of using one line per frame of closed captioning, several more lines can be used for encoding the data.

By encoding the data in VBI portions, the present invention enables any desired status messages to be displayed using the signals stored on video tape 130. For example, a user may be informed that data upgrade (modification) is being performed and that the upgrade process should not be interrupted. That is, status messages may be stored in the display signal portion to inform a user of any information that needs to be conveyed, and that information is automatically displayed when video tape 130 is played. The data modification can be performed in parallel as the data used for modification is stored in non-display portions (e.g., in VBI portion).

The recovery scheme needs to be generally consistent with the storage and transmission steps of above. Any data synchronization signals included in the data encoded in the received video signal can be used during the recovery process. Several recovery schemes will be apparent to one skilled in the relevant arts.

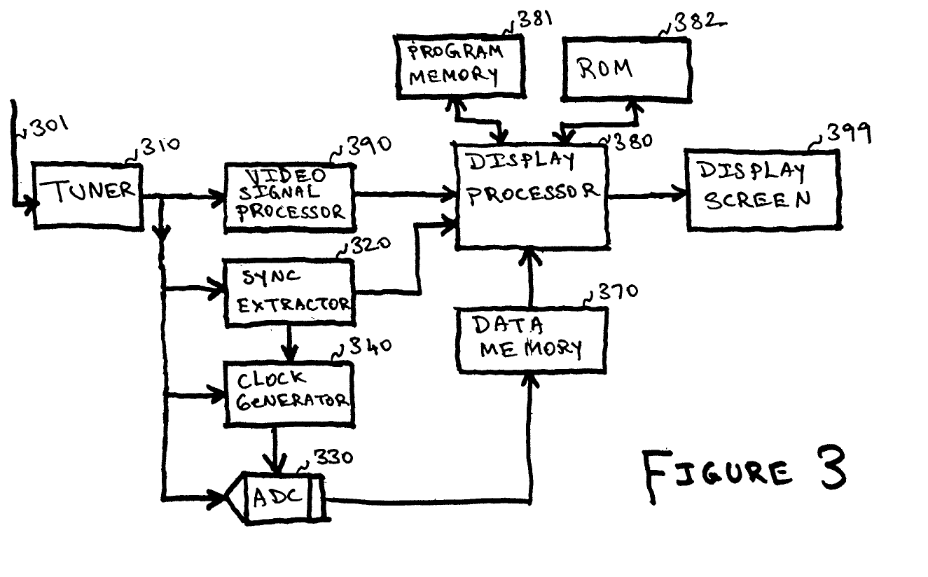

Once recovered, the data may be used to modify pre-stored data in a known way in step 250. For example, the recovered data may replace all or some of pre-stored data. The manner in which software programs can be modified (or upgraded) in an example embodiment of the present invention is described below with reference to FIG. 3.

3. An Embodiment of Television System Implementing the Present Invention

The present invention can be implemented in any television system which display images encoded in analog television signals. Such television systems include those based on analog (e.g., using CRTs) technology, digital technologies (e.g., HDTV), or the like. FIG. 3 is a block diagram of an embodiment of television system (TV) 110 in which the present invention can be implemented. Broadly, program memory 381 is used to store software instructions (of one or more programs). Several features are provided by television system 110 by executing the stored instructions. The data representing the software instructions is replaced in accordance with the present invention as described herein.

Tuner 310 receives a television signal corresponding to multiple channels on line 301 and extracts the television signal corresponding to a channel. In the present application, the television signal corresponding to a channel will be referred to as a video signal. A video signal typically includes display data signals and video synchronization signals. The display data signals identify the color intensity of various points on an image to be displayed and the video synchronization signals provide a time reference for the display data signals such that the image can be constructed from the display data. The received video signal can include data synchronization signals which enable the accurate recovery of the data encoded in the video signal.

Sync extractor 320 extracts the video synchronization signals (e.g., HSYNC and VSYNC of a composite video signal) and provides the extracted signals to display processor 380. Analog-to-digital converter (ADC) 330 receives a video signal and samples the received signal according to the clock signal generated by clock generator 340. The sampled values are stored in data memory 370.

Video signal processor 390 may process the display data portion of a video signal in a desired manner. For example, video signal processor 390 may digitize the display data portion to generate digital pixel data elements representative of images encoded in the video signal. The pixel data elements may be used by display processor 380 to display the images on display screen 399.

Clock generator 340 receives the video synchronization signals from sync extractor 320 and any data synchronization signals encoded in a video signal. Clock generator 340 generates a clock signal synchronized with the data synchronization signals in a known way. Accurate synchronization generally enables ADC 330 to sample the video signal at appropriate places to recover the encoded data. Analog-to-digital converter (ADC) 330 receives a video signal and samples the received signal according to the clock signal generated by clock generator 340.

The manner in which the sampling clock can be synchronized with any data synchronization signals will be apparent to one skilled in the relevant arts. Even though synchronization in the present application is described with reference to synchronization using data synchronization bits, it should be understood that other techniques can be used as well.

A processor such as display processor 380 executes programs (instructions) defined by data stored in program memory 381 to provide various features. For example, display processor 380 may combine the display of the data (treated as network application data accessed from an external source) stored in data memory 370 with images encoded in television signals as described in RELATED APPLICATION 2. The data stored in data memory 370 may be used to modify the data in program memory 381 as described herein.

In general, display processor 380 may need to determine whether the data recovered and stored in data memory 370 needs to be used for modifying the data in program memory 381. In one embodiment, a user is provided the option to press one or more buttons in a pre-defined sequence or manner, which indicates to the display processor 380 that the data can be used for modifying the data in program memory 381. In such an embodiment, a user plays a video tape supplied for upgrading the stored program, and messages may be displayed requesting the user to press a predetermined sequence of buttons.

Display processor 380 may then start using the recovered data for modifying the program data. In an alternative embodiment, a predetermined sequence of bits may be encoded on video tape 130, which triggers the modification of data using the recovered data. Other techniques for determining when to modify the program data can be used as will be apparent to one skilled in the relevant arts at least based on the disclosure herein, and such techniques are within the scope and spirit of the present invention.

The process of updating the data in program memory 381 may entail running a program. Often, provision needs to be made for television system 110 to recover should any error situations (e.g., user aborting the update process in the middle) occur. Accordingly, any data necessary for such recovery may be stored in read-only-memory (ROM) 382. The data stored may include the program used for modifying the data in program memory 381 and any default configuration parameters. If the updating process is determined to have failed, the data stored in ROM 382 can be used to configure (or restore data in) program memory 381.

Even though program memory 381 and ROM 382 are described as two separate blocks, it should be understood that both can be implemented using a single memory unit. For example, some blocks of a flash memory can be used to store program data and other blocks can be used to store any data required for recovery from the modification process. It should also be understood that the present invention can be used to modify data in any type of memory (sequential, random, registers etc.). It should be further understood that even though the program data is described as executed by display processor 380, the data modified in accordance with the present invention can be used by other processors (including video signal processor 390) for other purposes as well.

Display processor 380 generates signals compatible with display screen 399 in a known way to display the combined image of the recovered digital data (when not used for updating data in program memory 381) and video signal images. Display processor 380 may store any digital pixel data elements representing images in the recovered digital data and the images encoded in the display data portion of the video signal in another memory (not shown) as described in further detail in RELATED APPLICATION 4. Using the stored pixel data elements, display processor 380 may display either combined overlaid images of the images encoded in the video signals on the images representing recovered digital data.

Thus, the present invention can be used to modify data such as program instructions in television systems. The modification feature enables the programs to be updated and the configuration data in television systems to be modified.

4. Alternative Embodiment of Television System Implementing the Present Invention

Several embodiments can be implemented in accordance with the present invention. In the embodiment(s) described with reference to FIG. 3, clock generator 340 may need to be accurately synchronized with any data synchronization bits provided in a video signal. Accurate synchronization may require expensive crystals, and the resulting high cost may be unacceptable in certain situations.

Accordingly, the data on the tape is encoded in a format similar to that in which teletext data is encoded and the encoded portion of video signal is sampled at a high frequency to generate several sample data elements. The sampled data elements are examined to determine the appropriate samples which represent the encoded data. Several embodiments implementing such a technique are described in RELATED APPLICATION 4, which is incorporated in its entirety herewith. Using the embodiments there, the digital data encoded on video tapes can be recovered in television systems. The recovered data can be used to modify any pre-stored data in the television systems.

Thus, as the present invention enables the modification of data in television systems using mostly pre-existing external hardware (video tapes and VCPs), data can be modified without requiring any external special servers (such as computers) for transmitting new data. In addition, the update process is simplified from an end-user perspective as the user needs to simply play a video usually on a pre-existing VCP.

5. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method of modifying pre-stored data in a television system, said method comprising the steps of:
(a) storing new data on a video storage medium;
(b) reproducing said new data in the form of a video signal by playing said video storage medium in a video player;
(c) receiving said video signal in said television system;
(d) recovering said new data in said video signal; and
(e) modifying said pre-stored data by using said new data recovered in step (d).

2. The method of claim 1, wherein step (e) comprises the step of replacing at least a portion of said pre-stored data by said new data.

3. The method of claim 1, wherein step (a) comprises the step of storing said new data in a vertical blanking interval portion of said video signal.

4. The method of claim 1, wherein said video signal is in an NTSC signal format.

5. The method of claim 1, wherein step (a) comprises the further step of storing a plurality of data synchronization bits on said video storage medium and wherein step (d) comprises the further steps of:
(f) generating a sampling clock signal synchronized with said plurality of data synchronization bits; and
(g) sampling said video signal using said sampling clock to generate a plurality of sampled data elements, wherein said sampled data elements represent said new data recovered in step (d).

6. The method of claim 1, wherein at least a portion of said pre-stored data represents program instructions.

7. The method of claim 1, wherein said pre-stored data is stored in a random access memory.

8. A television system comprising:
memory means for storing data;
receiving means for receiving a video signal from a video player, wherein new data is encoded in said video signal;
recovering means coupled to said receiving means, said recovering means for recovering said new data encoded in said video signal; and
replacement means coupled to said memory means and said recovering means, said replacement means for replacing at least a portion of said data stored in said memory using said new data recovered by said recovering means;
whereby said data stored in said memory means can be modified by a user by playing a video storage medium in said Video player, wherein said new data is stored on said video storage medium.

9. The television system of claim 8, wherein said memory means comprises a random access memory.

10. The television system of claim 11, wherein said recovery means comprises:
a clock generator for generating a sampling clock signal; and
an analog-to-digital converter (ADC) coupled to said clock generator and said tuner, said ADC receiving said video signal from said tuner and generating a plurality sampled data elements by sampling said video signal according to said sampling clock, wherein said plurality of sampled data elements represent said new data.

11. The television system of claim 8, further comprising an interlaced display screen for displaying any images encoded in said video signal.

12. A television system comprising:
a memory for storing data;
a tuner for receiving a video signal from a video player, wherein new data is encoded in said video signal;
recovering means coupled to said tuner, said recovering means for recovering said new data encoded in said video signal; and
a processor coupled to said memory and said recovering means, said processor for replacing at least a portion of said data stored in said memory using said new data recovered by said recovering means;
whereby said data stored in said memory means can be modified by a user by playing a video storage medium in said video player, wherein said new data is stored on said video storage medium.

13. The television system of claim 12, wherein said memory comprises a random access memory.

14. The television system of claim 12, wherein said recovery means comprises:
a clock generator for generating a sampling clock signal; and
an analog-to-digital converter (ADC) coupled to said clock generator and said tuner, said ADC receiving said video signal from said tuner and generating a plurality sampled data elements by sampling said video signal according to said sampling clock, wherein said plurality of sampled data elements represent said new data.

15. The television system of claim 14, wherein said video signal includes data synchronization signals, and wherein said clock generator is designed to generate said sampling clock signal synchronized with said data synchronization signals.

16. The television system of claim 15, wherein said data synchronization signal comprises a clock run-in signal.

17. The television system of claim 12, wherein at least a portion of said pre-stored data represents program instructions.

18. The television system of claim 12, wherein said video storage medium comprises a video tape and said video player comprises a video cassette player.
